(19) United States
(12) Patent Application Publication
(10) Pub. No.: US 2011/0213795 A1
(43) Pub. Date: Sep. 1, 2011

(54) Automatic creation of alternative layouts using the same selected photos by applying special filters and/or changing photo locations in relation to creating the photobook

(76) Inventors: Kenneth Kun Lee, Oakton, VA (US); Young il Kim, Herdon, VA (US)

(21) Appl. No.: 12/660,533

(22) Filed: Mar. 1, 2010

(51) Int. Cl. G06F 7/10; G06F 17/30

(52) U.S. Cl. 707/769; 707/E17.014

(57) ABSTRACT

A system and a method are disclosed for generating photo books using digital images by using pre-assigned templates and pre-assigned filters designed for a particular type of an event, such as weddings and portraits. The placement of the photos and subsequent processing of the photos using pre-defined templates and filters wherein by intelligently selecting and creating page spreads based on limited user information of a number of photos in a single page layout. Based on an original layout, present system and method provides alternate layouts wherein the same images are filtered and/or locations of the images are changed.

### FIELD OF THE INVENTION

The present application relates to a method and system of creating different image layouts in a photo album.

### BACKGROUND OF THE INVENTION

Digital photo images are typically generated by a digital camera. Once captured, it can be further processed using image processing software, such as Adobe Photoshop. In most cases, however, the images are stored as is or printed using a high-quality printer to be viewed. In some cases, users can create a book of photos, in which case, users may take a group of printed photos and rearrange them into a photo book. Users can also send the photos electronically to online photo processing software service through the internet. For example, the customer can use the internet browser (such as Internet Explorer) to direct the browser to a photo processing server network. The photo processing website arranges the photos per user's direction and creates a photo album that typically has multiple photos in a single page. In addition to the photo placement, further image processing takes place to enhance overall look of the album. Once the processing is finished, the final design is sent to the user in JPEG format to be printed. Or, if the user desires, the photo processing site can print the photo album and ship it to the user by Post Office or any of express shipping companies.

As shown in FIG. 1, a local computer having digital photos taken by users are transmitted electronically via internet to a storage server 11. The storage server 11 comprises a memory 15 to store photos where the photos may be stored in different selectable templates rearranged them into a photo book.

However, in order to enhance the overall quality of the pictures or the photo book, the photos may be applied with special effects, such as blurring, shadow, black and white, pencil sketch, and oil paint. Adobe Photoshop or other similar software may be used to add these special effects to the pictures. But this must be done prior to sending the photos to the storage server 11. Furthermore, the templates available in the storage server may have a limited number of options that may not meet user's expectation. On the other hand, having too much of templates may be time consuming to a user to go overall each one of them. Some of the templates may be not a good fit, since templates support a certain number of images. Therefore, this application is related to creating a photo album where a user is automatically given with a desired number of templates based on a user selected number of images.

### SUMMARY OF THE INVENTION

An apparatus and a method of providing alternate layouts in a photo album are disclosed. The present invention discloses a method, the method of receiving a set of images having x number of images, wherein the set of images are images received from a remote system and stored in a memory of a storage server; searching in the memory for the alternate layouts with x number of images from a set of templates, by an image processing server (IPS) that is coupled to the storage server; selecting n number of layouts, wherein each of the n number of layouts having x number of images; placing the set of images in each of the selected layouts following the same order of an original layout, based on pre-defined template information of at least one of the selected layouts; if said pre-defined template information includes at least one pre-defined filter parameter associated with said pre-defined template information of at least one of the selected layouts, applying one or more filters to at least one image of the set of images, by the image processing server (IPS), based on said at least one pre-defined filter parameter; and providing n number of alternate layouts to the remote system; wherein n and x are integers.

Present invention discloses an apparatus for providing alternate layouts in a photo album, the apparatus comprising a storage server comprising a memory configured to store images received from a remote system, pre-defined template information, and a plurality of pre-defined filter parameters; an image processing server (IPS) coupled to the storage server being configured to: search in the memory for the alternate layouts with x number of images from a set of templates, by the IPS that is coupled to the storage server; select n number of layouts, wherein each of the n number of layouts having x number of images; place the set of images in each of the selected layouts following the same order of an original layout, based on pre-defined template information of at least one of the selected layouts; if said pre-defined template information includes at least one pre-defined filter parameter associated with said pre-defined template information of at least one of the selected layouts, apply one or more filters to at least one image of the set of images, by the image processing server (IPS), based on said at least one pre-defined filter parameter; and provide n number of alternate layouts to the remote system.

In one embodiment, selecting n number of layouts is performed by a random generator randomly selecting the n number of layouts.

In another embodiment, said selecting n number of layouts is based on a criterion of selecting layouts with minimum number of conversions between portrait and landscape of the set of images.

The pre-defined filter parameter associated with said pre-defined template information performs at least one of blurring, shadow, black and white, pencil sketch, and oil paint functions.

The template information of a spread includes information of Template identification number, Page number, Name, Category, number of images, spread width, spread height, background color, and location of sample picture.

The template Information of an image includes information of image index, template identification number, spread number, image identification, spread width, spread height, image layer, image location, font style, text, angle of picture, location of original image, and filter identification.

### BRIEF DESCRIPTION OF THE DRAWINGS

FIG. 1 is a block diagram of system for uploading images from a local computer to a server in order to create a photo album.

FIG. 2 is a block diagram of an embodiment of uploading images from a local computer to a server for creating a photo album with enhanced features.

FIG. 3 is a flowchart illustrating one method for processing images.

FIG. 4 is an example of a spread or page in a template.

FIG. 5 is a flowchart illustrating a method for providing alternate layouts.

FIG. 6 is a block diagram of an embodiment of selecting a number of spreads with a selected number of images.

FIG. 7 is an example of an initial layout with four images in the layout.

FIG. 8 is an example of a first alternate layout with the same four images of the initial layout applied in a different layout setting.

FIG. 9 is an example of a second alternate layout with the same four images of the initial layout applied in another different layout setting.

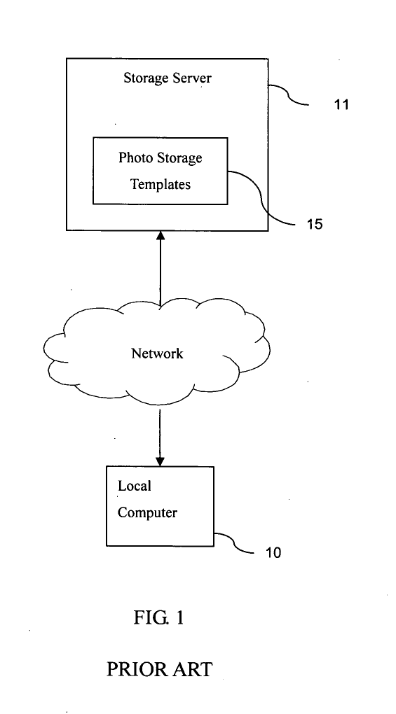

### DETAILED DESCRIPTION

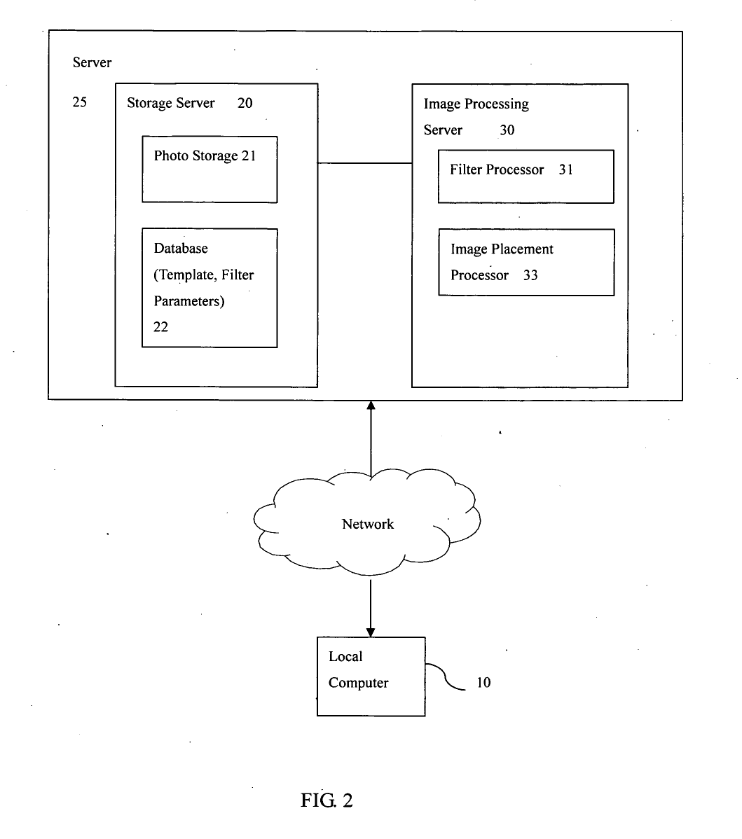

In FIG. 2, a user transmits images from a local computer 10 to a server 25 through a network or the internet. The storage server comprises photo storage 21, and a memory 22. In addition to the storage server 20, image processing server (IPS) 30 is connected to the storage server. The IPS includes filter processor 31, and image placement processor 33.

Uploaded images or photos from the local computer are stored in the memory 21. Database 22 is stored with pre-defined templates, pre-defined parameters, and pre-defined filter parameters. The database and the photo storage may be any type of memory device capable of storing data.

Filter processor 31 executes different parameters by retrieving parameters stored in the database. Image Placement Processor (IPS) 33 is responsible for placement of each of the images in the template. The server 25 may be configured as a single server, wherein the server 25 may perform functions of both IPS and the storage server.

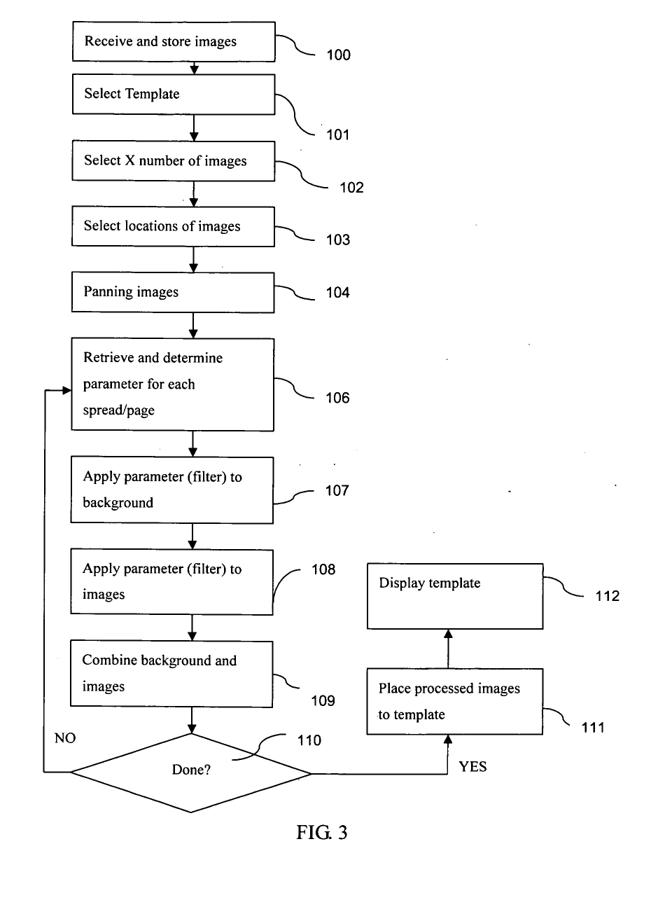

The following describes the steps performed in FIG. 2. In step 100 of FIG. 3, the storage server 20 receives images transmitted by a user from local computer 10 and stores the images in the photo storage 21. The user then selects a template from a list of different templates stored in a database or memory 22. Each of the templates includes plurality of spread and/or pages wherein each of the spread/page is designed to include different number of images. The templates are stored in the memory and are retrieved by IPS when required. The templates are pre-defined with pre-assigned parameters, such as filter, number of spreads or pages, number of images in each spread or page, location of the images, angle rotation and other parameters. By selecting a first template from a list of pre-defined templates, images are processed based on first pre-assigned parameters. And by selecting a second template, images are processed based on second pre-assigned parameters or pre-defined template information.

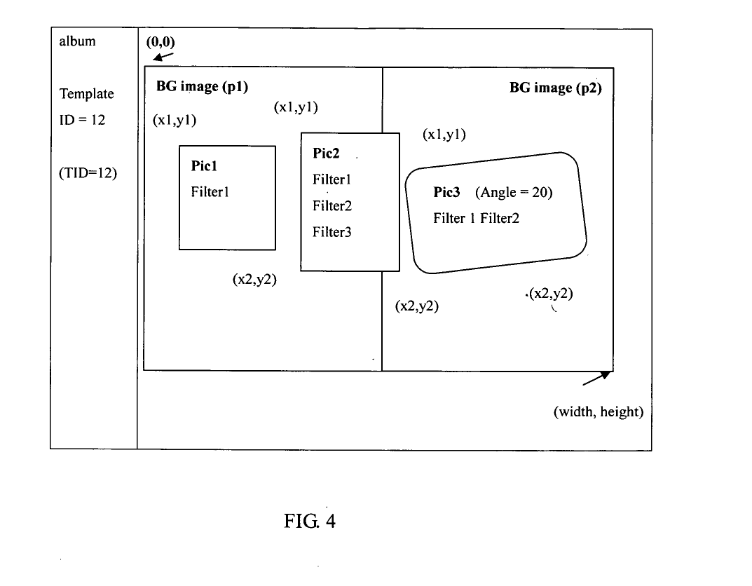

In FIG. 4, an exemplary template selected by a user shows a spread of the template supporting three images and two background images. The user can select images for each of the image locations 103. For example, a first image is selected for the image location Pic1, a second image is selected for image location Pic2, and a third image is selected for image location Pic3. As illustrated in FIG. 4, an image may also be given an angle to the image for a rotated position of the image. The positions of each of the images are identified by its width and height (x1, x2, y1, y2).

The user may also control panning and zooming functions to move the image within the image location for a desired fit 104. The spread in a template, and the page in the template are interchangeable in the embodiment depending on whether the photo book is a wedding album, in this case spreads may be used, or the photo book is a portrait, then, pages may be used.

After the user assigns images to corresponding images locations in the spread/page of the template, template information of spread/page and template information of images are processed by the IPS. IPS associates each of the images with its respective pre-defined parameters. IPS processes each of the images by spread number, image number, location (such as, top, left, box size, zoom factor), angle, font size, title, and filter parameter retrieved from the memory 22, in step 106. IPS retrieves pre-defined template information including template information of a spread and template information of an image from memory 22, based on a desired template selected by the user in step 101. The template information of a spread and the template information of an image is further described in relation to Table 1 and Table 2. While IPS retrieves the template information based on the selection made in step 101, IPS also retrieves filter parameters (including FilterID), based on the retrieved pre-defined template information. The memory 22 having stored with pre-defined template information and a plurality of pre-defined filter parameters, the selected template by the user may include template information implementing different filter parameters. Thus, corresponding filter parameters are retrieved from a pool of filter parameters stored in the memory 22, based on the template information of the selected template, in step 106.

IPS applies filter, borderline, background color, text addition, banner, shadow, and other features necessary to enhance the look of the background images 107. Each of the images assigned to the spread/page is also processed to apply filter, borderline, background color, text addition, banner, shadow, and other desirable features to enhance the look of the images 108 based on the template information that is associated with pre-defined filter parameters.

The processing of the first spread/page is complete after combining the background image and the images have been applied with the pre-defined parameters in step 109. Separate processing for the background may be optional, which then step 109 would be omitted.

IPS determines if there are more spread/page to be processed, 110. Steps 106 to 109 are repeated until all of the spread/page for the template have been completed, and then proceeds to step 111 of placing all processed spread/page into the template. The server is now ready to transmit the processed images in the form of the selected template back to user for display to the local computer 112. The final result with the filtered images in the templates is displayed to the user. As a result, the user can experience the convenience of creating a photo book by simply selecting a template, uploading images, and selecting images to its respective locations in the template.

Depending on the filter parameters of the template, IPS performs its respective filtering function. IPS performs one or more than one filter functions depending on the filter parameter of the template. And after all of the images have been processed, the filtered images are placed into its respective spreads of the templates 108.

After viewing the images, if a user wishes to view with a different template, the user may select a new template. The corresponding template information of the new template would be retrieved from the database. This new template information of the new template has different template information with its respective filter parameters that may vary from the initial template information. Thus, a first image of a first page or spread assigned with a blurring filter in the first template may be assigned with a shadowing effect to a first image of a first page or spread in a second template. This can be executed properly because each of the templates has its own corresponding template information with different pre-defined filter parameters.

Therefore, each of the pre-defined templates is associated with template information having pre-defined filter parameters, wherein the filter parameters are assigned to each of the images in the template. IPS filters the images based on the pre-defined filter parameters retrieved from database. The database stored in memory 22 includes Template Information of a spread, and Template Information of an image.

The template information stored in the database is pre-defined and is retrieved in response to user's template selection. Thus, each of the spreads and each of the images in the templates are associated with the Template Information.

The template information of a spread includes information of Template identification number (TemplateID) of a unique identification number, Page number (PageID) where the spread number starts from zero to a finite number of available spread number, Name of spread, Category of spread, Category identification number, number of images (Photos), spread width (Width), spread height (Height), background color (optional), and location of sample picture (SrcImg).

The Template Information of an image includes information of image index (Photo Index), template identification number (TemplateID), spread number (PageID), image identification (ImageID, 0 for background image, 1 for first image on the background, 2 for second image, and so on), spread width (Width), spread height (Height), image layer (Layer, 0 for bottom layer, 1 for one layer higher than bottom layer, 2 for two layers higher than bottom layer), image location (x1, y1, x2, y2), font style (FontStyleID), text, angle of image (Angle, rotation angle of image or picture), location of original image (SrcImg), and filter identification (FilterID, filter applied to the picture, using delimiter to apply multiple filters).

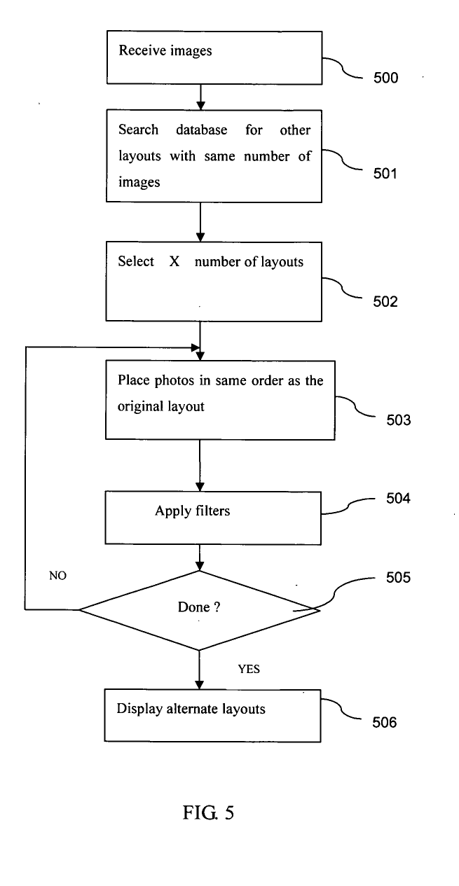

In FIG. 5, the algorithm illustrated provides alternate layouts. After a user has viewed initial or original template with photos or images selected by the user, an option to view alternate layouts is provided to the user, wherein the same images of the initial layout (wherein the layout is a spread for wedding, and the layout is a page for a portrait) is presented in one or more alternate layouts that has the same images. The spreads or pages in the alternate layouts have different image locations, parameters, and filters from the initial layout.

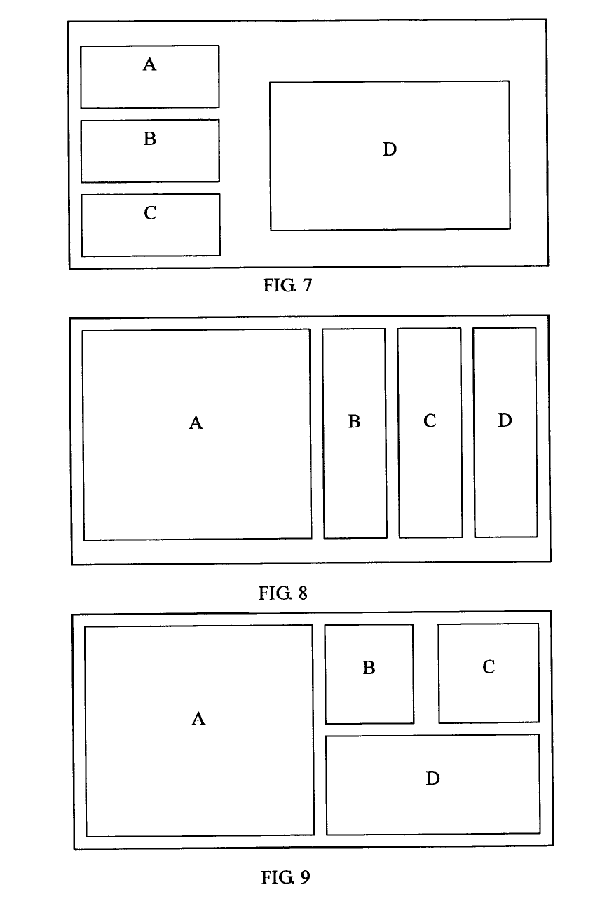

FIGS. 7-9 shows exemplary images of alternate layouts. The top spread is the original spread selected by the user. The user may also view the same images in different layouts, as shown with the second layout in FIG. 8 and the third layout in FIG. 9. The image location D in the original layout of FIG. 7 is located at the far right side in the second layout in FIG. 8, and the same is located at the bottom right in the third layout of FIG. 9. Applying one or more than one filters to the images depends on the filter parameter. Thus, images in the original spread may or may not be applied with filter and placed in corresponding image locations in the alternate layouts. By providing alternate layouts, the user has options to select a layout that the user desires. The number of alternate layouts is not limited to a specific number, but the two alternate layouts of FIG. 8 and FIG. 9 are only to provide as an example.

IPS 30 receives information from the storage server 20 of the following: actual images in the original layout, the number of images in the original layout, number of alternate templates to be presented to the user, and filter parameters. The pre-defined filter parameters associated with pre-defined template information of the selected layouts are also retrieved from the memory, and IPS applies corresponding filters to the images in the original layout. Applying filters to the images are based on the pre-defined filter parameters.

In order to describe the steps performed in FIG. 5, a scenario is given as: after a user creates a layout with a set of images, the user wishes to view the same images in different layouts. Images in the original layout include X number of images. In step 501, IPS searches database for other layouts (spreads or pages) with the same number of images.

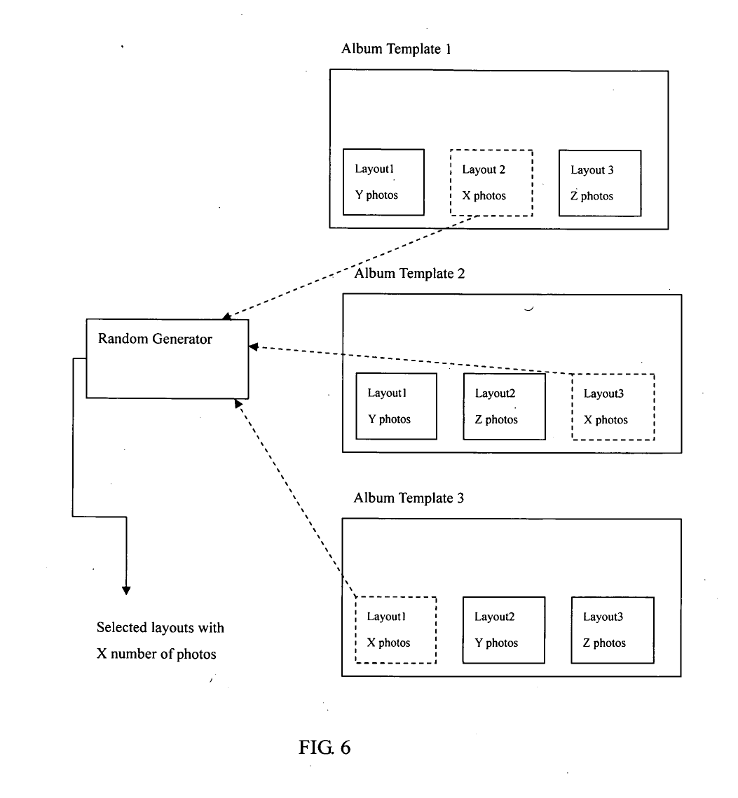

In one embodiment, FIG. 6 shows one embodiment of searching the database and selecting different layouts. In each of the album templates 610, 620, 630, resides plurality of layouts (pages or spreads) with different number of photos/images in each. Layout1 610a of the album template 1 has Y number of photos, while the number of photos IPS is searching for is X number of photos (N, X, Y, and Z may be any number of integers). Thus, Layout1 of the album template is not selected as a candidate. Going through different pages, IPS selects Layout2 from album template 1. This search is also performed in other album templates, including album template 2 (selecting Layout3), album template 3 (selecting Layout1), and so on. Since the original layout includes X number of images, the pages having X number of images from each of the album templates are provided to random generator 601. Random generator randomly selects N number of layouts out of the plurality of layouts having X number of layouts.

In another embodiment, step 502 is performed by selecting layouts that meets a criterion. In the original spread, the images could be in landscape or in portrait. Converting an image from landscape to portrait may not be desirable, and vice versa. Thus, in step 502, among the layouts with X number of images, layouts are selected based on the requirement with minimum number of conversion of images between landscape and portrait when applying the images to the alternate layouts.

If the original layout comprises two landscape images and one portrait image, the alternate layouts with two landscape images and one portrait image would be selected over a layout with different number of landscape and portrait images. In step 503, the same images in the original layout are placed in each of the N spreads in the same order of the original layout. Image 1 positioned in position 1 of the original layout is also positioned in position 1 at each of the N layouts. The rest of the images in the original layout are placed in its respective positions.

In step 504, one or more filters are applied to the images using the filter parameters. Applying one or more than one filters to the images depends on the template information, which may or may not include applying one or more filters. In order to apply proper pre-defined filters to each of the alternate layouts, the filter parameters of each of the alternate layouts are retrieved, wherein each of the filter parameters are associated with a corresponding template information. The detailed steps of applying filters are as described in reference to FIG. 3. If pre-defined template information includes at least one pre-defined filter parameter to apply one or more filters to an image in an image position of the layout, then the image located in the corresponding position is applied with one or more filters, by the image processing server (IPS), based on said at least one pre-defined filter parameter.

After processing steps 503 and 504 to each of the images to each of the selected n layouts, determines that processing of steps 503, and 504 are complete. Then, the same images in the original spread are placed in corresponding locations, applied with proper filters (depending on the template information), and displayed to the user 506.

After viewing the alternate layouts, the user can select one of the alternate layouts as the layout for those images in the photo book. Hence, the user can easily create a photo book with minimal effort as the present system and method automatically creates different layouts.

The embodiments of the invention have been presented for purpose of description and illustration and are not intended to be exhaustive or to limit the invention to the forms disclosed. The scope of the invention is defined by the appended claims, not the preceding disclosure.

What is claimed is:

1) A method of providing alternate layouts in a photo album, the method comprising:
receiving a set of images having x number of images, wherein the set of images are images received from a remote system and stored in a memory of a storage server;
searching in the memory for the alternate layouts with x number of images from a set of templates, by an image processing server (IPS) that is coupled to the storage server;
selecting n number of layouts, wherein each of the n number of layouts having x number of images;
placing the set of images in each of the selected layouts following the same order of an original layout, based on pre-defined template information of at least one of the selected layouts;
if said pre-defined template information includes at least one pre-defined filter parameter associated with said pre-defined template information of at least one of the selected layouts, applying one or more filters to at least one image of the set of images, by the image processing server (IPS), based on said at least one pre-defined filter parameter; and
providing n number of alternate layouts to the remote system;
wherein n and x are integers.

2) The method of claim 1, wherein said selecting n number of layouts is performed by a random generator randomly selecting the n number of layouts.

3) The method of claim 1, wherein said selecting n number of layouts is based on a criterion of selecting layouts with minimum number of conversions between portrait and landscape of the set of images.

4) The method of claim 1, wherein said at least one pre-defined filter parameter performs at least one of blurring, shadow, black and white, pencil sketch, and oil paint functions.

5) An apparatus for providing alternate layouts in a photo album, the apparatus comprising:
a storage server comprising a memory configured to store images received from a remote system, pre-defined template information, and a plurality of pre-defined filter parameters;
an image processing server (IPS) coupled to the storage server being configured to:
search in the memory for the alternate layouts with x number of images from a set of templates, by the IPS that is coupled to the storage server;
select n number of layouts, wherein each of the n number of layouts having x number of images;
place the set of images in each of the selected layouts following the same order of an original layout, based on pre-defined template information of at least one of the selected layouts;
if said pre-defined template information includes at least one pre-defined filter parameter associated with said pre-defined template information of at least one of the selected layouts, apply one or more filters to at least one image of the set of images, by the image processing server (IPS), based on said at least one pre-defined filter parameter; and
provide n number of alternate layouts to the remote system;
wherein n and x are integers.

6) The apparatus of claim 5, wherein said selecting n number of layouts is performed by a random generator randomly selecting the n number of layouts.

7) The apparatus of claim 5, wherein said selecting n number of layouts is based on a criterion of selecting layouts with minimum number of conversions between portrait and landscape of the set of images.

8) The apparatus of claim 5, wherein said at least one pre-defined filter parameter performs at least one of blurring, shadow, black and white, pencil sketch, and oil paint functions.
